(19) United States
(12) Patent Application Publication
(10) Pub. No.: US 2020/0117576 A1
(43) Pub. Date: Apr. 16, 2020

(54) ASSESSING THE CONTAINER-READINESS OF SOFTWARE APPLICATIONS

(71) Applicant: CA, Inc., New york, NY (US)

(72) Inventors: Venkata Swamy Karukuri, Hyderabad (IN); Anil Kumar Sutrala, Hyderabad (IN); Murali Krishna Segu, Hyderabad (IN)

(21) Appl. No.: 16/158,749

(22) Filed: Oct. 12, 2018

(51) Int. Cl. G06F 11/36; G06F 8/75; G06F 11/34

(52) U.S. Cl. CPC G06F 11/3612; G06F 11/3466; G06F 8/75; G06F 11/3664

(57) ABSTRACT

Techniques are disclosed relating to assessing the container-readiness of a software application. In some embodiments, a computer system performs an assessment of the container-readiness of a software application relative to a specified containerization procedure. The assessment may be based on a plurality of parameters associated with the software application. In some embodiments, the assessment includes parsing program code associated with the software application to determine, for one or more static parameters, corresponding static parameter scores. The assessment may further include analyzing runtime information corresponding to the software application to determine a runtime parameter score for at least one runtime parameters. Further, the assessment may include generating a container-readiness value for the software application based on the runtime parameter score and the static parameter scores. In some embodiments, the container-readiness value is indicative of a degree of compliance with the specified containerization procedure.

### BACKGROUND

### Technical Field

This disclosure relates generally to software development, and more particularly to assessing the readiness of a software application for deployment via a container.

### Description of the Related Art

Many software applications have been designed for deployment in an on-premises environment. Recently, however, it has become increasingly desirable to deploy software applications as containers in a software as a service (“SaaS”) environment, due to the increased flexibility and scalability that containerization provides. Accordingly, many entities have sought to migrate software applications that were originally designed as on-premises applications to deployment via containers in a SaaS environment. Not all on-premises software applications are amenable to deployment via containers, however, and there are a number of factors that must be assessed when determining whether an on-premises application can feasibly be containerized. This determination—whether a software application can be migrated from an on-premises environment to containers—is often a complex and time-consuming project, requiring extensive analysis of the software application in question and intimate knowledge of containerization principles.

### SUMMARY

Techniques are disclosed relating to assessing the container-readiness of a software application. In some embodiments, a computer system performs an assessment of the container-readiness of a software application relative to a specified containerization procedure. The assessment may be based on a plurality of parameters associated with the software application. In some embodiments, the assessment includes parsing program code associated with the software application to determine, for one or more static parameters, corresponding static parameter scores. In some embodiments, for example, the one or more static parameters may include at least one of a size of the software application, deployment dependencies associated with the software application, or software packages utilized by the software application. The assessment may further include analyzing runtime information corresponding to the software application to determine a runtime parameter score for at least one runtime parameters. In some embodiments, for example, the at least one runtime parameter may correspond to a CPU usage level of a computing device when executing the software application in a test environment. Further, the assessment may include generating a container-readiness value for the software application based on the runtime parameter score and the static parameter scores. In some embodiments, the container-readiness value is indicative of a degree of compliance with the specified containerization procedure.

### BRIEF DESCRIPTION OF THE DRAWINGS

FIG. 1 is a block diagram illustrating an example system for assessing the container-readiness of software applications, according to some embodiments.

FIG. 2 includes block diagrams illustrating an example on-premises deployment environment and an example container-based deployment environment for a software application, according to some embodiments.

FIG. 3 is a block diagram illustrating a more-detailed depiction of a program code analysis module, a runtime information analysis module, and a container-readiness value generation module, according to some embodiments.

FIG. 4 is a flow diagram illustrating an example method for assessing the container-readiness of a software application, according to some embodiments.

FIGS. 5A-5C depict an example embodiment in which a container-readiness value is generated for a particular software application, according to some embodiments.

FIG. 6 is a block diagram illustrating an example computer system, according to some embodiments.

### DETAILED DESCRIPTION

In the past, it was common practice to design enterprise software applications for deployment in an on-premises environment. In recent years, however, it has become increasingly cost-effective and technically feasible to deploy enterprise applications in a SaaS environment. For example, application deployment through SaaS can offer improved flexibility and scalability relative to an on-premises deployment, while reducing costs associated with establishing and maintaining on-premises infrastructure. One popular SaaS technique is containerization, in which a software application is packaged with all of its requisite libraries and dependencies and run on host machine as a container. Containers also offer several benefits over application deployment via virtual machines (“VMs”). For example, VMs are created and managed by a hypervisor, and each VM on a host machine typically requires its own guest operating system. Containers, by contrast, run directly within the host machine's kernel, and the host machine is not required to implement a hypervisor. As a result, containers are lighter and more-quickly instantiated than VMs, and a given host machine can typically host more containers than it could corresponding VMs.

Accordingly, many entities have sought to migrate software applications that were originally designed as on-premises applications to deployment as containers in a SaaS environment. Due to the differences between their original development environment and the desired containerization deployment environment, however, not all on-premises software applications are good candidates for deployment via containers, and there are a number of factors that must be assessed when determining whether an on-premises application can feasibly be containerized. For example, on-premises applications that require extensive local configurations to their host machines, are large (e.g., one or more gigabytes) in size, or rely on specific hardware integration may be difficult to transition to a container-based deployment. In some instances, it may be more time- and cost-effective to entirely redesign a software application specifically for containerization than it would be to simply modify the software application in its current state. This determination—whether a software application can be readily migrated from an on-premises environment to deployment via one or more containers—is often a complex and time-consuming technical problem, requiring extensive analysis of the software application in question and intimate knowledge of containerization principles.

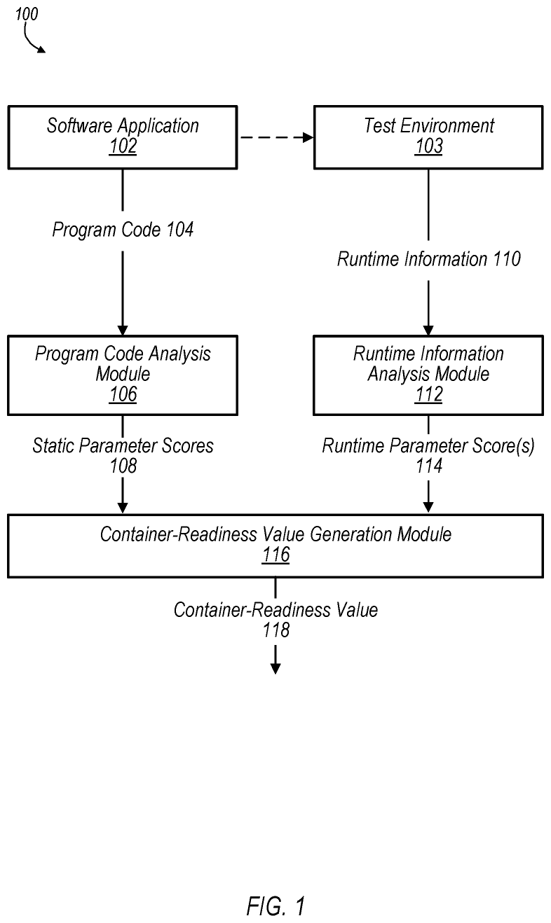

Referring now to FIG. 1, a block diagram illustrating a system 100 for assessing the container-readiness of software applications is depicted, according to some embodiments. In various embodiments, system 100 is operable to analyze various aspects of a software application, based on various parameters relevant to containerization, and generate a container-readiness value that is indicative of a degree of compliance of the software application with a specified containerization platform, such as the Docker Enterprise container platform by Docker, Inc.

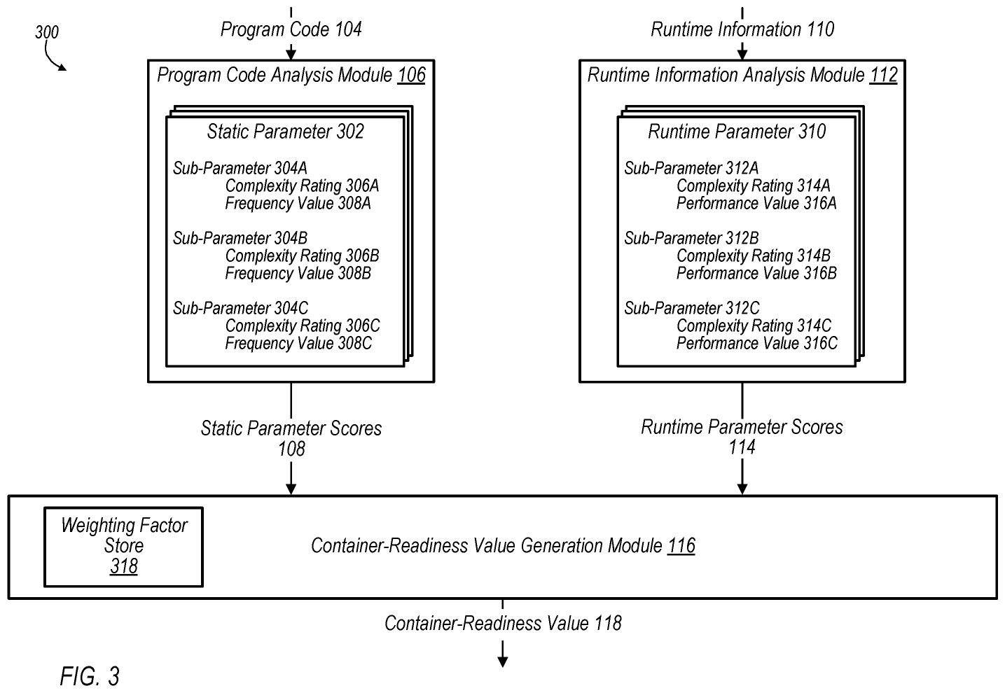

In the depicted embodiment, system 100 assesses the container-readiness of software application 102. System 100 may receive software application 102, or information associated with software application 102, as part of a request to assess its container-readiness. In various embodiments, the disclosed systems and methods may assess the container-readiness of software applications based on various parameters relevant to containerization. In some embodiments, these parameters include “static parameters,” which, as used herein, are factors associated with a software application that may be assessed without executing the software application itself. In some embodiments, static parameters may be assessed by analyzing program code associated with the software application. Non-limiting examples of static parameters include the size of a software application, deployment dependencies associated with the software application, or software packages utilized by the software application. In FIG. 1, system 100 includes program code analysis module 106, which, in various embodiments, is operable to analyze program code 104 (e.g., source code, assembly code, etc.) associated with software application 102 to determine static parameter scores 108 for various static parameters. Example embodiments for determining the static parameter scores 108 will be discussed in more detail below with reference to FIG. 3. For the purposes of FIG. 1, note that program code analysis module 106, in various embodiments, is operable to analyze program code 104 to determine the extent to which a plurality of static parameters are present in software application 102. Program code analysis module 106 may then generate a static parameter score 108 for each of these static parameters based, in part, on the extent to which they are present in application 102.

The container-readiness of a software application may also be assessed on the basis of one or more “runtime parameters,” which, as used herein, are factors associated with a software application that may be assessed by analyzing runtime information corresponding to a test execution of the software application. Note that, in at least some embodiments, the disclosed systems and methods may generate a container-readiness value for a software application without reliance on any distinction between static and runtime parameters. Instead, in some such embodiments, a parameter score may simply be determined for each of the parameters for which a given software application 102 is being assessed. In FIG. 1, system 100 includes test environment 103, which in various embodiments is a controlled environment (e.g., a sandbox) in which software application 102 may be executed. In various embodiments, test environment 103 may log information about the execution of software application 102 to generate runtime information 110. Runtime information 110 may include various items of information associated with the execution of software application 102, such as the CPU usage requirements of executing software application 102, the memory usage of application 102, or any other suitable performance metric. Note, however, that in some embodiments, system 100 may not include test environment 103. Instead, runtime information 110 associated with the software application 102 may be provided to system 100, for example as part of the request to assess the container-readiness of the application 102. FIG. 1 further includes runtime information analysis module 112, which in various embodiments is operable to analyze the runtime information 110 corresponding to software application 102 to determine a runtime parameter score 114 for each of the runtime parameters being evaluated. As with program code analysis module 106, example embodiments of runtime information analysis module 112 will be described in more detail below with reference to FIG. 3.

System 100 further includes container-readiness value generation module 116, which in various embodiments is operable to generate a container-readiness value 118 for the software application 102 based on the runtime parameter score(s) 114 and the static parameter scores 108. For example, container-readiness value generation module 116, in various embodiments, includes or has access to weighting factors for the parameters used to assess the container-readiness of software application 102. Container-readiness value generation module 116 may use these weighting factors to generate weighted versions of the static parameter scores 108 and runtime parameter scores 114, which in turn may be used to generate container-readiness value 118. As noted above, this container-readiness value 118 is indicative of a degree of compliance of software application 102 with a specified containerization platform, such as Docker Enterprise container platform or any other suitable alternative. Stated differently, the container-readiness value 118, in some embodiments, is indicative of the readiness of the software application in question for deployment as a container. For example, in some embodiments, a relatively high container-readiness value 118 may indicate that few modifications need to be made to software application 102 before it may be successfully deployed as a container. In such an instance, the software application 102 may be considered a good candidate for containerization. Conversely, in some embodiments, a relatively low container-readiness value 118 may indicate that extensive changes need to be made to the software application 102 (e.g., by removing hardware dependencies, modifying network communication behavior of the application 102, etc.) before it may be successfully deployed as a container. In such an instance, the software application 102 may be considered a poor candidate for containerization and it may be deemed more prudent to instead redesign the application 102 specifically for containerization, rather than adapting the existing application architecture. Note, however, that these embodiments are described merely as an example and are not intended to limit the scope of the present disclosure. In other embodiments, container-readiness values 118 may be generated such that the degree of compliance with a specified containerization platform increases as the value 118 decreases, etc.

The present disclosure addresses technical problems in the field of software development and, more specifically, software containerization. As noted above, the determination of whether a software application can be migrated from an on-premises environment to deployment via one or more containers is often a complex and time-consuming technical problem. Depending on the complexity of the software application in question, such a determination can take weeks or months of time and effort to resolve. Various embodiments of the present disclosure, however, provide a technical solution to this technical problem, thereby improving the process of assessing the container-readiness of a software application and the software development process as a whole. For example, by assessing the container-readiness of a given software application 102 using system 100, the determination of whether to migrate the software application 102 from an on-premises deployment to deployment via containers may be made very quickly and with a high degree of precision, saving time and effort on the part of one or more software engineers. This, in turn, may reduce the expense and time required to migrate a software application from an on-premises environment to deployment via containers. Further, in some embodiments, the disclosed systems and methods may prevent the migration to containers of a software application that is a poor candidate for containerization. Instead, using various disclosed embodiments, it may be determined that, rather than attempting to migrate the application in its existing state to containers, such time and effort would be better spent redesigning the application to be inherently more amenable to containerization.

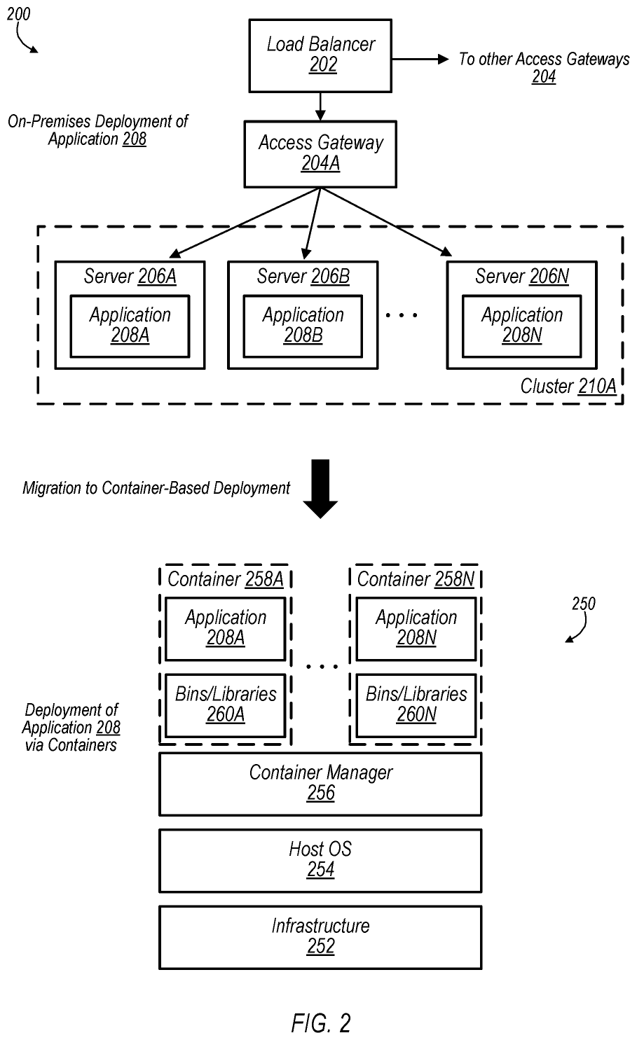

FIG. 2 includes block diagrams depicting both an on-premises deployment and a container-based deployment of a software application, according to some embodiments. More specifically, block diagram 200 shows one embodiment of an on-premises deployment of a software application 208. In diagram 200, the on-premises deployment environment includes load balancer 202, access gateway 204A, and cluster 210A that includes various servers 206. Note that, as indicated in diagram 200, the on-premises environment may include additional access gateways 204 and clusters 210, in various instances. In the on-premises deployment, client requests are received by the load balancer 202, which routes the request through one of various access gateways 204 to an instance of application 208 executing on one of the servers 206. For example, a client request may be received by load balancer 202, routed through access gateway 204A and ultimately to software application 208B executing on server 206B. This routing may be performed on a round-robin basis or using any other suitable technique.

In some instances, use of an on-premises environment, such as that depicted in block diagram 200, may require significant overhead costs to establish, implement, and maintain the various components shown in FIG. 2. As noted above, it has become increasingly desirable to deploy software applications, such as application 208, as containers in a SaaS environment, due to the increased flexibility and scalability that containerization provides, as well as the reduced overhead expenses. Various embodiments of the present disclosure provide systems and methods for assessing the container-readiness of a software application. For example, in some embodiments, the disclosed systems and methods may be used to determine whether a software application initially designed for an on-premises environment can be feasibly modified such that it can be containerized, or whether the modification efforts are better spent redesigning the application specifically for containerization. For example, in some embodiments, container-readiness value 118 may be used as such an indicator. In some such embodiments, in response to the container-readiness value 118 exceeding some threshold value, a software application may be migrated from an on-premises deployment to a deployment via containers, as depicted in block diagram 250.

Block diagram 250 shows a container-based deployment of application 208, for example as part of a SaaS environment, according to one embodiment. As shown in diagram 250, the container-based deployment environment includes infrastructure 252, host OS 254, container manager 256, and various containers 258A-258N. Within each container 258 is an instance of application 208 packaged with its necessary binary files, composition files, and libraries 260.

Containerization can offer a number of benefits over an on-premises deployment of application 208, in various instances. For example, as noted above, containers are lightweight and can be quickly instantiated in response to increased need. Additionally, containers typically require less overhead costs to establish and maintain on-premises infrastructure. In various embodiments, a software application may migrated from an on-premises deployment to a container-based deployment based, at least in part, on a container-readiness value generated for the software application. For example, in response to a container-readiness value 118 for software application 102 exceeding a predetermined threshold, containerization operations may be initiated to migrate the application 208 from the on-premises environment to a container-based environment.

Referring now to FIG. 3, a block diagram 300 is shown illustrating a more detailed depiction of program code analysis module 106, runtime information analysis module 112, and container-readiness value generation module 116, according to some embodiments.

In various embodiments, program code analysis module 106 is operable to parse program code 104 associated with software application 102 and to determine, for one or more static parameters, corresponding static parameter scores 108. In the depicted embodiment, program code analysis module 106 parses program code 104 to assess the software application 102 on the basis of a variety of static parameters, include static parameter 302. As shown in FIG. 3, static parameter 302 includes three sub-parameters 304A-304C, each of which has a complexity rating 306A-306C, respectively. As used herein, a “complexity rating” is a value assigned to a given parameter or sub-parameter that is indicative of the difficulty to containerization posed by the presence of the given parameter or sub-parameter within a software application 102. That is, the complexity rating is indicative of the complexity involved in modifying a particular aspect of the software application (e.g., by finding a suitable alternative implementation) such that the application can be deployed as a container. Note that the presence of some parameters or sub-parameters may pose very little impediment to containerization, and the corresponding complexity ratings for those parameters or sub-parameters may be indicative of this (e.g., by having a relatively low complexity rating). For example, consider an embodiment in which static parameter 302 is software packages utilized by the software application 102, and sub-parameter 304A is the OS packages used by the application 102. In some embodiments, this sub-parameter 304A—the OS packages used—may not pose a significant obstacle to migrating the application 102 to a container. Accordingly, in some such embodiments, sub-parameter 304A may be assigned a complexity rating 306A that is relatively low, such as a 1 on a scale from 1 to 10.

The presence of other parameters or sub-parameters, however, may pose a more-significant obstacle to containerization of the software application and, accordingly, the corresponding complexity ratings for those parameters or sub-parameters may indicate this increased difficulty (e.g., by having a relatively high complexity rating). Continuing with the above example, sub-parameter 304B may be the specific hardware integrations the application 102 relies on in operation. In some embodiments, this presence of this sub-parameter 304B—the hardware integrations utilized—may pose a significant obstacle to migrating the application 102 to a container. Accordingly, in some such embodiments, sub-parameter 304B may be assigned a complexity rating that is high, such as a 10 on a scale from 1 to 10. Note that this embodiment is provided merely as an example and is not intended to limit the scope of the present disclosure. In various embodiments, the specific sub-parameters 304 will vary depending on the particular static parameter 302 with which they are associated.

In various embodiments, program code analysis module 106 may parse program code 104 to determine the extent to which various static parameters and sub-parameters are present in software application 102. Program code analysis module 106 may then assign a frequency value 308 (e.g., a numerical value between 1 and 10, or on any other suitable scale) to one or more of the sub-parameters 304 based on the extent to which the sub-parameters 304 are present in the program code 104. For example, if there are many instances of a particular sub-parameter 304 (e.g., sub-parameter 304C) present in the program code 104, program code analysis module 106 may assign a relatively high frequency value 308 (e.g., frequency value 308C, in this example), to the sub-parameter 304. If instead, however, there are few or no instances of a particular sub-parameter present in the program code 104, program code analysis module 106 may assign a relatively low frequency value 308 to the sub-parameter 304.

In various embodiments, program code analysis module 106 is operable to use the frequency values 308 and complexity ratings 306, for each of the sub-parameters 304 associated with static parameter 302, to determine a static parameter score 108 for static parameter 302. This process may be repeated for each of the various static parameters 302 for which the application 102 is being assessed. The manner in which program code analysis module 106 generates the static parameter scores 108 may vary, according to different embodiments. In some embodiments, program code analysis module 106 may generate the static parameter scores 108 as follows:

$${S}_{i} = \frac{\sum {C}_{ij} {V}_{ij}}{\sum {C}_{ij}} \qquad ( 1 )$$

Where Sᵢ is the parameter score for a given parameter i, Cᵢⱼ is the complexity of a given sub-parameter j for a given parameter i, and Vᵢⱼ is the frequency value of the given sub-parameter j for the given parameter i, where the summation is performed over the index value j. For example, based on Equation 1, the static parameter score 108 for static parameter 302 would be as follows: S₃₀₂=complexity rating 306A*frequency value 308A+complexity rating 306B*frequency value 308B+complexity rating 306C*frequency value 308C, according to some embodiments. Program code analysis module 106 may repeat this process to determine a static parameter score 108 for each of the static parameters for which the software application 102 is being assessed. Note, however, that this embodiment is provided merely as an example and is not intended to limit the scope of the present disclosure. In other embodiments, program code analysis module 106 may generate the static parameter scores 108 using other suitable techniques.

FIG. 3 further includes a more-detailed depiction of runtime information analysis module 112, according to some embodiments. In various embodiments, runtime information analysis module 112 is operable to analyze runtime information 110 corresponding to software application 102 to determine a runtime parameter score 114 for at least one runtime parameter. For example, in the depicted embodiment, runtime information analysis module 112 analyzes runtime information 110 to assess the software application 102 on the basis of a variety of runtime parameters, including runtime parameter 310. In the depicted embodiment, runtime parameter 310 is associated with three sub-parameters 312A-312C. Similar to the sub-parameters 304, each of the sub-parameters 312 is associated with a complexity rating 314. In various embodiments, the complexity ratings 314 are values indicative of the difficulty to containerization posed by the application 102's performance for the sub-parameters 312.

In various embodiments, runtime information analysis module 112 is operable to parse runtime information 110 to determine performance values 316 associated with each of the sub-parameters 312, where the performance values 316 are indicative of the level of software application 102's performance for the runtime sub-parameters 312. Runtime information analysis module 112 may, in various embodiments, use the complexity ratings 314 and performance values 316, for each of the sub-parameters 312 associated with runtime parameter 310, to determine a runtime parameter score 114 for the runtime parameter 310. This process may be repeated for each of the runtime parameters 310 for which the application 102 is being assessed. The manner in which runtime information analysis module 112 generates the runtime parameter scores 114 may vary, according to different embodiments. In some embodiments, runtime information analysis module 112 generate the runtime parameter scores 114 based on Equation 1, provided above. For example, based on Equation 1, the runtime parameter score 114 for runtime parameter 310 would be as follows: S310=complexity rating 314A*performance value 316A+complexity rating 314B*performance value 316B+complexity rating 314C*performance value 316C, according to some embodiments. Runtime information analysis module 112 may repeat this process to determine a runtime parameter score 114 for each of the runtime parameters for which the application 102 is being assessed. Note, however, that this embodiment is provided merely as an example and is not intended to limit the scope of the present disclosure. In other embodiments, runtime information analysis module 112 may generate the runtime parameter scores 114 using other suitable techniques.

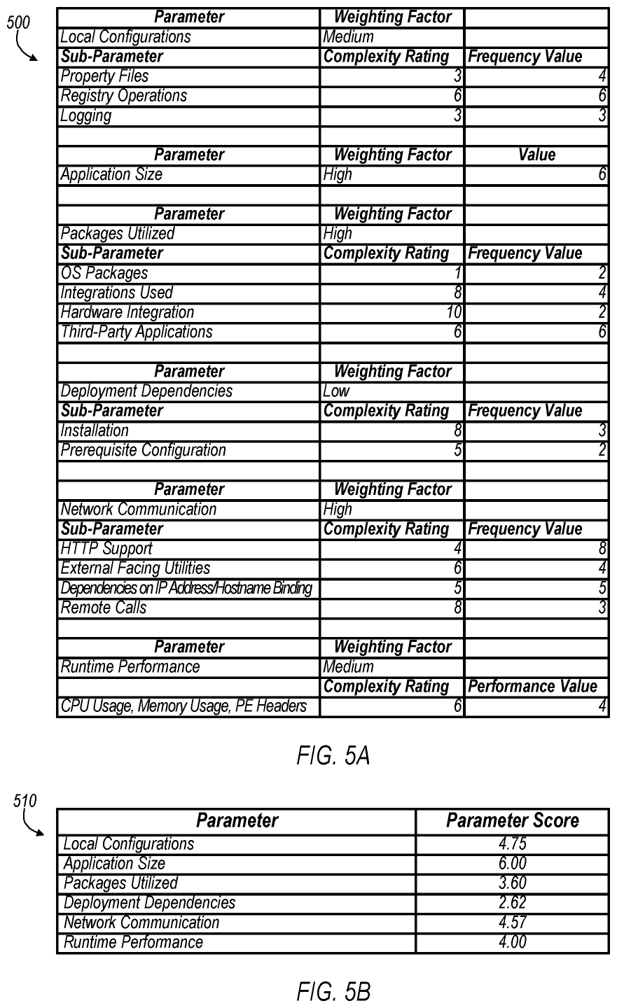

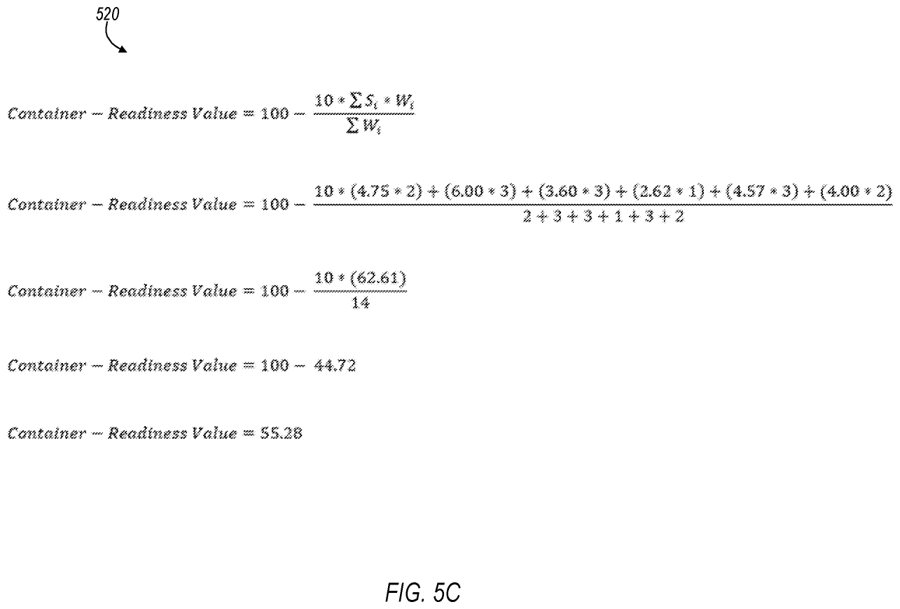

FIG. 3 further depicts container-readiness value generation module 116, which, in various embodiments, is operable to generate container-readiness value 118 based on the static parameter scores 108 and the runtime parameter scores 114. As shown in FIG. 3, container-readiness value generation module 116 includes weighting factor store 318. In various embodiments, each of the parameters for which the software application 102 is being assessed, including the static and runtime parameters discussed herein, is associated with a weighting factor, which may be stored in weighting factor store 318 (e.g., on a storage element of the computer system performing the container-readiness assessment). Container-readiness value generation module 116 may use these weighting factors to generate weighted versions of each of the static parameter scores 108 and runtime parameter scores 114, which in turn may be used to generate the container-readiness value 118. The manner in which container-readiness value generation module 116 generates the container-readiness value 118 may vary, according to different embodiments. In some embodiments, container-readiness value generation module 116 may generate the container-readiness value as follows:

$$S = 100 - \frac{10 * \sum {S}_{i} * {W}_{i}}{\sum {W}_{i}} \qquad ( 2 )$$

Where S is the container-readiness value 118, Sᵢ is the parameter score for a given parameter i (e.g., static parameter score 108, runtime parameter score 114, etc.), Wᵢ is the weighting factor for the given parameter i, and the summation is performed over the index i for each of the parameters for which the software application 102 is being assessed. A more detailed example for generating a container-readiness value 118 based on Equations 1 and 2 will be discussed below with reference to FIGS. 5A-5C. Note, however, that this embodiment is provided merely as an example and is not intended to limit the scope of the present disclosure. In other embodiments, container-readiness value generation module 116 may generate the container-readiness value 118 using other suitable techniques.

### Example Methods

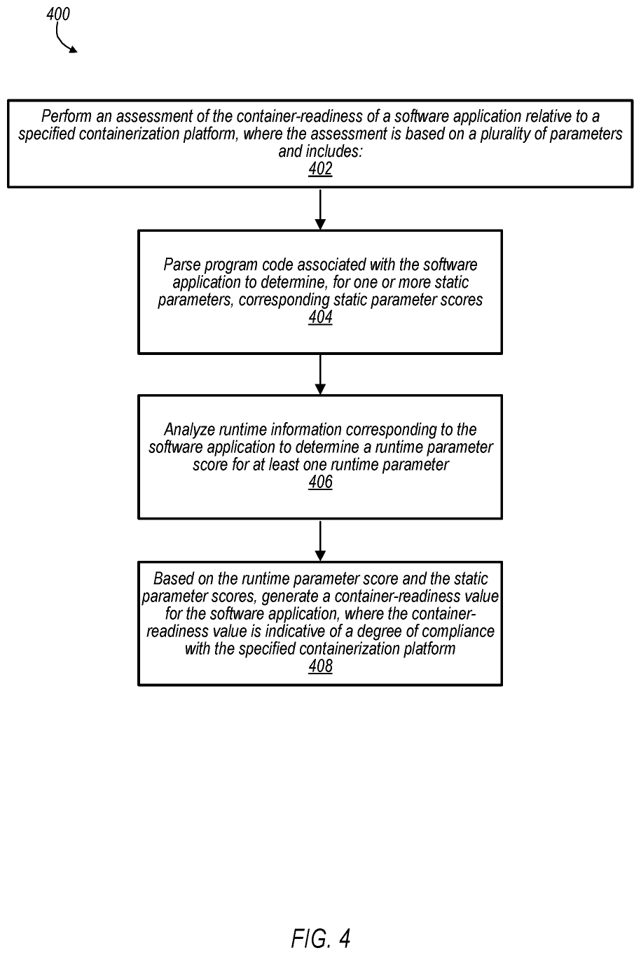

Turning now to FIG. 4, a flow diagram illustrating an example method 400 for assessing the container-readiness of a software application is depicted, according to some embodiments. In various embodiments, method 400 may be performed to assess the container-readiness of software application 102 of FIG. 1. In various embodiments, method 400 may be performed by a computer system that includes (or has access to) a non-transitory, computer-readable medium having program instructions stored thereon that are executable by the computer system to cause the operations described with reference to FIG. 4. In FIG. 4, method 400 includes elements 402-408. While these elements are shown in a particular order for ease of understanding, other orders may be used. In various embodiments, some of the method elements may be performed concurrently, in a different order than shown, or may be omitted. Additional method elements may also be performed as desired.

At 402, in the illustrated embodiment, a computer system performs an assessment of the container-readiness of a software application relative to a specified containerization platform. In various embodiments, the assessment is based on a plurality of parameters, such as static parameters and runtime parameters associated with the software application. In various embodiments, assessing the container-readiness of the software application includes elements 404-408. As noted above, however, one or more of elements 404-408 may be omitted in performing the assessment, and additional elements may also be performed as desired.

At 404, in the depicted embodiment, the computer system parses program code associated with the software application to determine, for one or more static parameters, corresponding static parameter score. For example, as discussed above with reference to FIG. 3, program code analysis module 106 may analyze program code 104 associated with software application 102 to determine one or more static parameter scores 108. In some embodiments, each static parameter includes one or more sub-parameters, and each of the sub-parameters is associated with a complexity rating. In FIG. 3, for example, static parameter 302 includes sub-parameters 304A-304C, each of which is associated with a complexity rating 306A-306C, respectively. Thus, in some embodiments, a given static parameter, of the one or more static parameters, includes one or more sub-parameters, and each of the one or more sub-parameters is associated with a complexity rating. Further, in some embodiments, determining, for a given static parameter, a corresponding static parameter score includes determining a frequency value for each of the one or more sub-parameters, and generating the corresponding static parameter score based on the frequency values 308 and the complexity ratings 306 for the one or more sub-parameters 304. Note that, in various embodiments, the container-readiness of the software application may be assessed on the basis of various static and runtime parameters. As will be discussed in more detail below with reference to FIGS. 5A-5C, the static parameters may include a size of the software application (which may be assessed without parsing the program code 104, in some embodiments), deployment dependencies associated with the software application, or software packages utilized by the software application.

At 406, in the depicted embodiment, the computer system analyzes runtime information corresponding to the software application to determine a runtime parameter score for at least one runtime parameter. For example, as discussed above with reference to FIG. 3, runtime information analysis module 112 may analyze the runtime information 110 to determine one or more runtime parameter scores 114. Note that, in some embodiments, method 400 may include executing the software application in a test environment and logging attributes associated with the execution of the software application to generate one or more items of runtime information. In other embodiments, however, the runtime information may be generated by another, potentially separate entity and the runtime information 110 may be provided to the computer system performing the assessment of container-readiness of the software application 102.

In some embodiments, each of the runtime parameters 310 includes one or more sub-parameters 312, and each of the sub-parameters 312 is associated with a complexity rating 314. In various embodiments, determining, for a given runtime parameter 310, a corresponding runtime parameter score 114 includes determining a performance value 316 for each of the one or more sub-parameters, and generating the corresponding runtime parameter score based on the performance values 316 and the complexity ratings 314 for the one or more sub-parameters. In some embodiments, a runtime parameters may correspond to a CPU usage level of a computing device when executing the software application in a test environment. Note, however, that this embodiment is provided merely as an example and, as discussed in more detail below with reference to FIGS. 5A-5C, various suitable runtime parameters may be utilized as desired.

At 408, in the depicted embodiment, the computer system generates, based on the runtime parameter score and the static parameter scores, a container-readiness value for the software application. For example, as discussed above with reference to FIG. 3, container-readiness value generation module 116 may use static parameter scores 108 and the runtime parameter score(s) 114 to generate a container-readiness value 118. In some embodiments, each of the plurality of parameters (including both the static and runtime parameters) is associated with a corresponding weighting factor. In some such embodiments, generating the container-readiness value 118 is based on weighted versions of the plurality of parameter scores corresponding to the plurality of parameters. In various embodiments, the container-readiness value is indicative of a degree of compliance with the specified containerization platform. In some embodiments, the degree of compliance corresponds to a containerization procedure used by the specified containerization platform. For example, in some embodiments, the specified containerization platform may correspond to Docker Enterprise container platform provided by Docker, Inc., and the degree of compliance may correspond to a particular containerization procedure used by the Docker Enterprise container platform. Further, in some embodiments, the container-readiness value includes information specifying those parameters, of the plurality of parameters, for which the software application fails to comply with the specific containerization platform. As one non-limiting example, the container-readiness value 118 may include information specifying parameters associated with network communication and software packages utilized as those parameters for which the software application 102 failed to comply with the specified containerization platform.

Note that, in some embodiments, method 400 may further include receiving, by the computer system from a user, input specifying an adjusted weighting factor for at least one of the plurality of parameters. In such embodiments, method 400 may further include generating an updated container-readiness value using the adjusted weighting factor. Additionally, in some embodiments, method 400 may further include receiving, from a user, a definition of a custom static parameter. In some such embodiments, element 404 may further include parsing the program code associated with the software application to determine a custom static parameter score for the custom static parameter, and element 408 may include generating the container-readiness value based on the custom static parameter score.

Further note that, in some embodiments, method 400 may further include initiating containerization operations for the software application using the specified containerization platform in response to the container-readiness value exceeding a predetermined threshold. In one non-limiting embodiment, for example, method 400 may include initiating containerization operations (e.g., modifying aspects of the software application 102 in preparation for deployment via containers) in response to the container-readiness value 118 indicating that the application 102 is over 60% ready for containerization. Note, however, that this embodiment is provided merely as an example and is not intended to limit the scope of the disclosed systems and methods.

FIGS. 5A-5C illustrate an example embodiment in which a container-readiness value 118 is generated for a software application 102. More specifically, FIG. 5A includes a table 500 showing various items of information associated with a particular software application 102, such as parameters, complexity ratings, frequency values, and performance values, according to one embodiment. In FIG. 5B, a table 510 is depicted showing various parameters and their corresponding parameter scores for the particular software application 102. FIG. 5C depicts steps for determining a container-readiness value 118 for the particular software application 102 based on the information provided in tables 500 and 510 of FIGS. 5A and 5B. The process described with reference to FIGS. 5A-5C may be performed, for example, by system 100 of FIG. 1, according to some embodiments.

Referring now to FIG. 5A, table 500 shows details corresponding to six parameters for which the particular software application 102 is being assessed, according to the depicted embodiment. In table 500, the parameters include: the local configurations to the software application 102, the size of application 102, the software packages used by application 102, the deployment dependencies of application 102, the network communication features of application 102, and the runtime performance of the application 102. In some embodiments, the first five of these parameters may be considered static parameters, as discussed above, while the last of these parameters may be considered a runtime parameter. Note, however, that in some embodiments, the container-readiness value 118 may be generated without reliance on any distinction between static and runtime parameters. Instead, in some such embodiments, a parameter score may simply be determined for each of the parameters for which a given software application 102 is being assessed. Further note that the particular parameters used to assess the container-readiness of software applications may vary according to different embodiments. In various embodiments, however, the six provided parameters may provide a useful baseline for which to assess the container-readiness of a software application 102. In some embodiments, one or more parameters may be added to or omitted from the six parameters specified in table 500 of FIG. 5A.

In table 500, each of the parameters is associated with a weighting factor. As noted above, these weighting factors may be used, e.g., by container-readiness value generation module 116, to generate the container-readiness value based on one or more parameter scores. Note that, in the depicted embodiment, the weighting factors are designated as either “low,” “medium,” or “high,” rather than being given numerical values. In the depicted embodiment, these relative weighting designations are mapped to numerical values (specifically “1,” “2,” and “3,” respectively), which, as discussed in more detail below with reference to FIG. 5C, may be used to generate a container-readiness value 118. In other embodiments, however, the weighting factors of table 500 may instead be assigned numerical values.

In FIG. 5A, four of the parameters shown in table 500 include one or more sub-parameters, each of which has a corresponding complexity rating and frequency value. Note that, in table 500, each of the complexity ratings and frequency values are provided on a scale from 1 to 10. For example, in the depicted embodiment, a higher value for the complexity rating indicates a higher degree of difficulty to containerization posed by the presence of the respective sub-parameter. Further, in the depicted embodiment, a higher frequency value indicates a higher degree of presence of the sub-parameter within application 102. Note, however, that this embodiment is provided merely as an example and is not intended to limit the scope of the present disclosure. In other embodiments, the range and magnitude of these values may be specified in any other suitable manner (e.g., on a scale from 0-1, 1-5, etc.). As discussed above, these complexity ratings and frequency values may be used, e.g., by program code analysis module 106 or runtime information analysis module 112, to generate parameters scores for the respective parameters. For example, turning to FIG. 5B, table 510 depicts each of the six parameters and their corresponding parameter scores, according to one embodiment. In the depicted embodiment, the parameter scores in table 510 are calculated based on Equation 1 provided above. For example, in the depicted embodiment, the parameter score for the “local configurations” parameter may be calculated based on Equation 1 as follows:

$${S}_{localconfigurations} = \frac{( 3 * 4 ) + ( 6 * 6 ) + ( 3 * 3 )}{3 + 6 + 3} = 4.75$$

A similar process may be performed (e.g., by program code analysis module 106 or runtime information analysis module 112) to generate the parameter scores for the remaining five parameters provided in table 510. Note, however, that this embodiment is provided merely as an example and is not intended to limit the scope of the present disclosure. In other embodiments, the parameter scores may be generated according to other suitable techniques.

In the depicted embodiment, the weighting factors (shown in table 500) and the parameter scores (shown in table 510) are used to generate a container-readiness value 118 for the particular software application 102 being assessed. The manner in which the container-readiness value 118 is generated may vary according to different embodiments. In some embodiments, the container-readiness value 118 may be generated based on Equation 2 provided above. For example, FIG. 5C depicts an example process for generating a container-readiness value 118 for the particular software application 102 based on Equation 2. As shown in FIG. 5C, the depicted embodiment utilizes the parameter scores of table 510 and the weighting factors of table 500. In the depicted embodiment, Equations 1 and 2 are structured such that, the higher the container-readiness value 118, the more amenable the software application 102 is to containerization. For example, in the depicted embodiment, the container-readiness value 118 for the particular software application 102 is equal to 55.28, which may be used to assess whether to containerize application 102. In the present example, it may be determined that applications 102 that receive a container-readiness value 118 greater than 50 should be migrated from on-premises environments to deployment via containers and, as such, containerization operations may be initiated for the particular application 102 assessed in FIGS. 5A-5C. Note, however, that this particular threshold value is provided merely as an example.

Note, however, that the embodiment depicted in FIGS. 5A-5C is provided merely as an example and is not intended to limit the scope of the present disclosure. As will be appreciated by one of skill in the art with the benefit of this disclosure, various modifications may be made to Equations 1 and 2 provided above (such as adjustments to the scale of the container-readiness value, the weighting factors used to weight the parameter scores, the manner in which the complexity ratings, frequency values, or parameter scores are combined, etc.) that would result in a different numerical value for the container-readiness value in the depicted example. Such modifications are contemplated within various embodiments of the present disclosure.

### Example Computer System

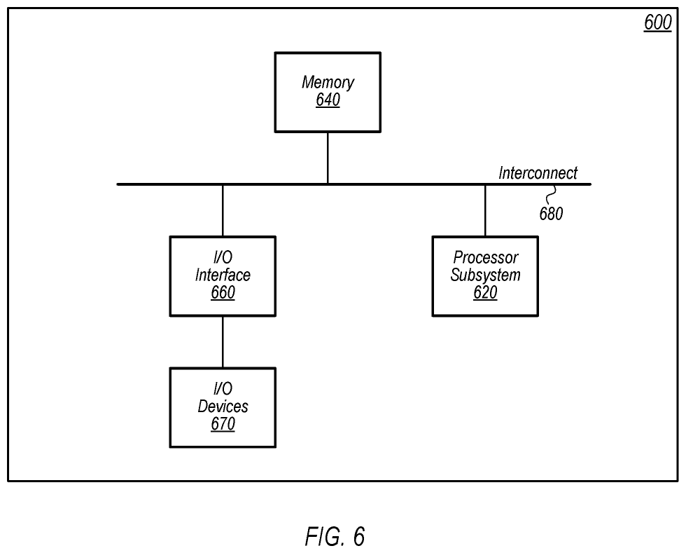

Referring now to FIG. 6, a block diagram of an example computer system 600 is depicted, which may implement one or more computer systems, such as a computer system operable to perform method 400 of FIG. 4, according to various embodiments. Computer system 600 includes a processor subsystem 620 that is coupled to a system memory 640 and I/O interfaces(s) 660 via an interconnect 680 (e.g., a system bus). I/O interface(s) 660 is coupled to one or more I/O devices 670. Computer system 600 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 600 is shown in FIG. 6 for convenience, computer system 600 may also be implemented as two or more computer systems operating together.

Processor subsystem 620 may include one or more processors or processing units. In various embodiments of computer system 600, multiple instances of processor subsystem 620 may be coupled to interconnect 680. In various embodiments, processor subsystem 620 (or each processor unit within 620) may contain a cache or other form of on-board memory.

System memory 640 is usable to store program instructions executable by processor subsystem 620 to cause system 600 perform various operations described herein. System memory 640 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 600 is not limited to primary storage such as system memory 640. Rather, computer system 600 may also include other forms of storage such as cache memory in processor subsystem 620 and secondary storage on I/O devices 670 (e.g., a hard drive, storage array, etc.). In some embodiments, these other forms of storage may also store program instructions executable by processor subsystem 620.

I/O interfaces 660 may be any of various types of interfaces configured to couple to and communicate with other devices, according to various embodiments. In one embodiment, I/O interface 660 is a bridge chip (e.g., Southbridge) from a front-side to one or more back-side buses. I/O interfaces 660 may be coupled to one or more I/O devices 670 via one or more corresponding buses or other interfaces. Examples of I/O devices 670 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 670 includes a network interface device (e.g., configured to communicate over WiFi, Bluetooth, Ethernet, etc.), and computer system 600 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, means “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” operable to perform designated functions are shown in the figures and described in detail above (e.g., program code analysis module 106, runtime information analysis module 112, container-readiness value generation module 116, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
performing, by a computer system, an assessment of container-readiness of a software application relative to a specified containerization platform, wherein the assessment is based on a plurality of parameters and includes:
parsing program code associated with the software application to determine, for one or more static parameters of the plurality of parameters, corresponding static parameter scores;
analyzing runtime information corresponding to the software application to determine a runtime parameter score for at least one runtime parameter; and
based on the runtime parameter score and the static parameter scores, generating a container-readiness value for the software application, wherein the container-readiness value is indicative of a degree of compliance with the specified containerization platform.

2. The method of claim 1, further comprising:
executing, by the computer system, the software application in a test environment; and
logging attributes associated with the execution of the software application to generate one or more items of the runtime information.

3. The method of claim 1, further comprising:
in response to the container-readiness value exceeding a predetermined threshold, initiating containerization operations for the software application using the specified containerization platform.

4. The method of claim 1, wherein a given static parameter, of the one or more static parameters, includes one or more sub-parameters, wherein each of the one or more sub-parameters is associated with a complexity rating; and wherein determining, for the given static parameter, the corresponding static parameter score comprises:
determining, for the software application based on the program code, a frequency value for each of the one or more sub-parameters; and
generating the corresponding static parameter score based on the frequency values and the complexity ratings for the one or more sub-parameters.

5. The method of claim 1, wherein each of the plurality of parameters is associated with a corresponding weighting factor; and wherein the generating the container-readiness value for the software application is based on weighted versions of a plurality of parameter scores corresponding to the plurality of parameters.

6. The method of claim 5, further comprising:
receiving, by the computer system from a user, input specifying an adjusted weighting factor for at least one of the plurality of parameters; and
generating an updated container-readiness value using the adjusted weighting factor.

7. The method of claim 1, wherein the one or more static parameters includes at least one of a size of the software application, deployment dependencies associated with the software application, or software packages utilized by the software application.

8. The method of claim 1, wherein the at least one runtime parameter corresponds to a CPU usage level of a computing device when executing the software application in a test environment.

9. The method of claim 1, wherein the degree of compliance corresponds to a containerization procedure used by the specified containerization platform.

10. The method of claim 1, further comprising:
receiving, from a user, a definition of a custom static parameter, wherein the parsing the program code associated with the software application includes determining a custom static parameter score for the custom static parameter, and wherein the generating the container-readiness value is based on the custom static parameter score.

11. The method of claim 1, wherein the container-readiness value includes information specifying those parameters, of the plurality of parameters, for which the software application fails to comply with the specific containerization platform.

12. A non-transitory, computer-readable medium having instructions stored thereon that are executable by a computer system to perform operations comprising:
assessing a container-readiness of a software application relative to a specified containerization platform, wherein the assessment is based on a plurality of parameters and includes:
parsing program code associated with the software application to determine, for one or more static parameters of the plurality of parameters, corresponding static parameter scores;
analyzing runtime information corresponding to the software application to determine a runtime parameter score for at least one runtime parameter; and
generating a container-readiness value for the software application based on the runtime parameter score and the static parameter scores, wherein the container-readiness value is indicative of a degree of compliance with the specified containerization platform.

13. The non-transitory, computer-readable medium of claim 12, wherein the operations further comprise:
executing, by the computer system, the software application in a test environment; and
logging attributes associated with the execution of the software application to generate one or more items of the runtime information.

14. The non-transitory, computer-readable medium of claim 12, wherein the operations further comprise:
in response to the container-readiness value exceeding a predetermined threshold, initiating containerization operations for the software application using the specified containerization platform.

15. The non-transitory, computer-readable medium of claim 12, wherein a given static parameter, of the one or more static parameters, includes one or more sub-parameters, wherein each of the one or more sub-parameters is associated with a complexity rating; and wherein determining, for the given static parameter, the corresponding static parameter score comprises:
determining, for the software application based on the program code, a frequency value for each of the one or more sub-parameters; and
generating the corresponding static parameter score based on the frequency values and the complexity ratings for the one or more sub-parameters.

16. The non-transitory, computer-readable medium of claim 15, wherein each of the plurality of parameters is associated with a corresponding weighting factor; and wherein the generating the container-readiness value for the software application is based on weighted versions of a plurality of parameter scores corresponding to the plurality of parameters.

17. The non-transitory, computer-readable medium of claim 12, wherein the operations further comprise:
receiving, from a user, a definition of a custom static parameter, wherein the parsing the program code associated with the software application includes determining a custom static parameter score for the custom static parameter, and wherein the generating the container-readiness value is based on the custom static parameter.

18. A computer system, comprising:
at least one processor;
a non-transitory, computer-readable medium having instructions stored thereon that are executable by the at least one processor to cause the computer system to perform operations, the operations comprising:
performing an assessment of container-readiness for a software application relative to a specified containerization platform, wherein the assessment is based on a plurality of parameters and includes:
parsing program code associated with the software application to determine, for one or more static parameters of the plurality of parameters, corresponding static parameter scores;
analyzing runtime information corresponding to the software application to determine a runtime parameter score for at least one runtime parameter; and
based on the runtime parameter score and the static parameter scores, generating a container-readiness value for the software application, wherein the container-readiness value is indicative of a degree of compliance with the specified containerization platform.

19. The computer system of claim 18, wherein a given static parameter, of the one or more static parameters, includes one or more sub-parameters, wherein each of the one or more sub-parameters is associated with a complexity rating; and wherein determining, for the given static parameter, the corresponding static parameter score comprises:
determining, for the software application based on the program code, a frequency value for each of the one or more sub-parameters; and
generating the corresponding static parameter score based on the frequency values and the complexity ratings for the one or more sub-parameters.

20. The computer system of claim 19, wherein each of the plurality of parameters is associated with a corresponding weighting factor; and wherein the generating the container-readiness value for the software application is based on weighted versions of a plurality of parameter scores corresponding to the plurality of parameters.
